(19) United States
(12) Patent Application Publication
(10) Pub. No.: US 2003/0229417 A1
(43) Pub. Date: Dec. 11, 2003

(54) Assembly for ensuring the integrity of its load and method associated therewith

(76) Inventors: Thomas Gyger, Les Ponts-de-Martel (CH); Olivier Desjeux, Le Landeron (CH)

Correspondence Address: SUGHRUE MION, PLLC, 2100 PENNSYLVANIA AVENUE, N.W., WASHINGTON, DC, 20037, US

(21) Appl. No.: 10/384,800

(22) Filed: Mar. 11, 2003

(30) Foreign Application Priority Data
Mar. 13, 2002 (EP) 02076009.6

(51) Int. Cl. G06F 7/00

(52) U.S. Cl. 700/222

(57) ABSTRACT

Assembly including a container (1) or a removable support (11) provided with a transponder (7, 16) and respectively filled or loaded with a plurality of units (2, 12) of goods. Each unit of goods is provided with a transponder (3, 14) including an identification number. The container or removable support transponder includes a check value determined as a function of the identification number of each transponder of said units of goods

The present invention concerns, in particular, an assembly including a container provided with a transponder and filled with a plurality of units of goods. It also concerns an assembly including a removable support provided with a transponder and loaded with a plurality of units of goods.

“Container” means, for example, a cardboard box or transport box, and “removable support” means, for example a transport palette or transport vehicle. The units of goods designate the various products that can be contained or loaded, respectively in a container or on a support.

Such assemblies comprising a container or a removable support and a plurality of units of goods are well known in the prior art. FR Patent document No. 2 717 593 discloses in particular a cardboard box capable of containing all sorts of products. The cardboard box is provided with a self-adhesive label incorporating a transponder containing, in particular, data corresponding to the products contained in the box.

DE Patent document No. 44 39 914 A1 discloses, in accordance with a variant, a transport pallet fitted with a transponder containing as data the type of load that it is carrying. A handling truck, capable of transporting such pallets, is fitted with an antenna for reading the data contained in the pallet transponder and thus checking that the load conforms.

Such solutions are implemented in most distribution networks in order to allow more efficient transport and better identification of the various products. These solutions have, however, some drawbacks. Indeed, it is entirely possible to envisage the content of a cardboard box or the load of a pallet being modified fraudulently or simply as a result of negligence or a mistake. Such modification of the content or load results in the removal, replacement or possibly the addition of goods.

The problem arises particularly in sectors of activity where goods are subject to strict regulations, such as for example in the tobacco industry or the pharmaceutical industry, or even in luxury sectors where goods are much more exposed to counterfeit and theft. It is to be noted that this problem arises more generally in all distribution networks.

According to the present invention, the integrity of the assemblies defined in the introductory paragraph is ensured, at any stage of the distribution network in a simple and reliable manner. It is one of the objects of the invention to prevent marketing of any fraudulent or counterfeit products capable of being introduced into the network.

Thus, in an assembly comprising a container or a removable support provided with a transponder and respectively filled or loaded with a plurality of units of goods, each unit of goods is provided with a transponder including in a memory, for example of the non-volatile type, an identification number, the container or support transponder including a check value determined as a function of the identification number of each transponder of the units of goods.

The invention also relates to the implementation of methods for checking the integrity of such assemblies, as well as the system for implementing this method. Other aspects and advantages will appear in light of the description.

The invention will now be explained in detail hereinafter via an embodiment given solely by way of example, this example being illustrated by the annexed drawings, in which:

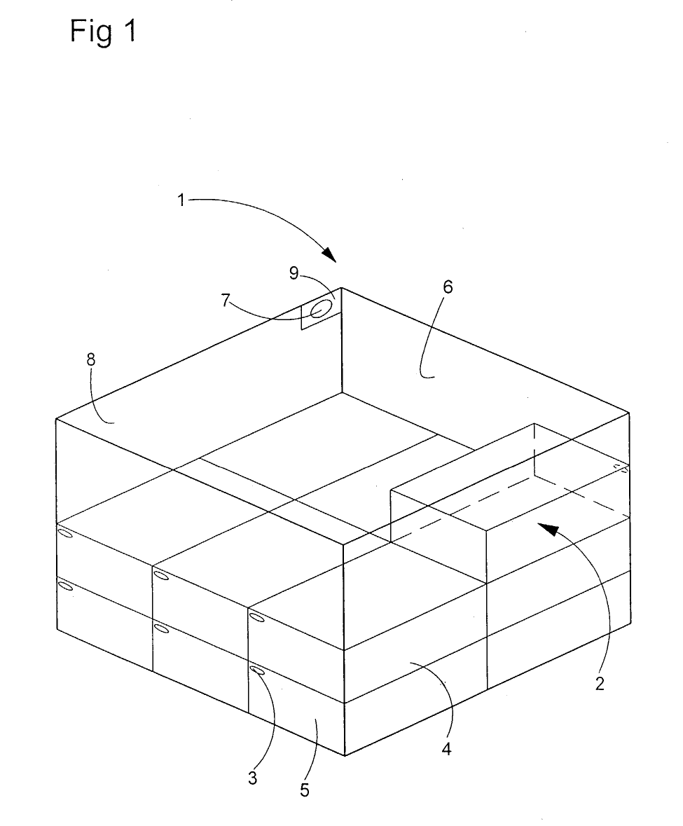

FIG. 1 shows an assembly comprising a container, according to a first embodiment of the invention,

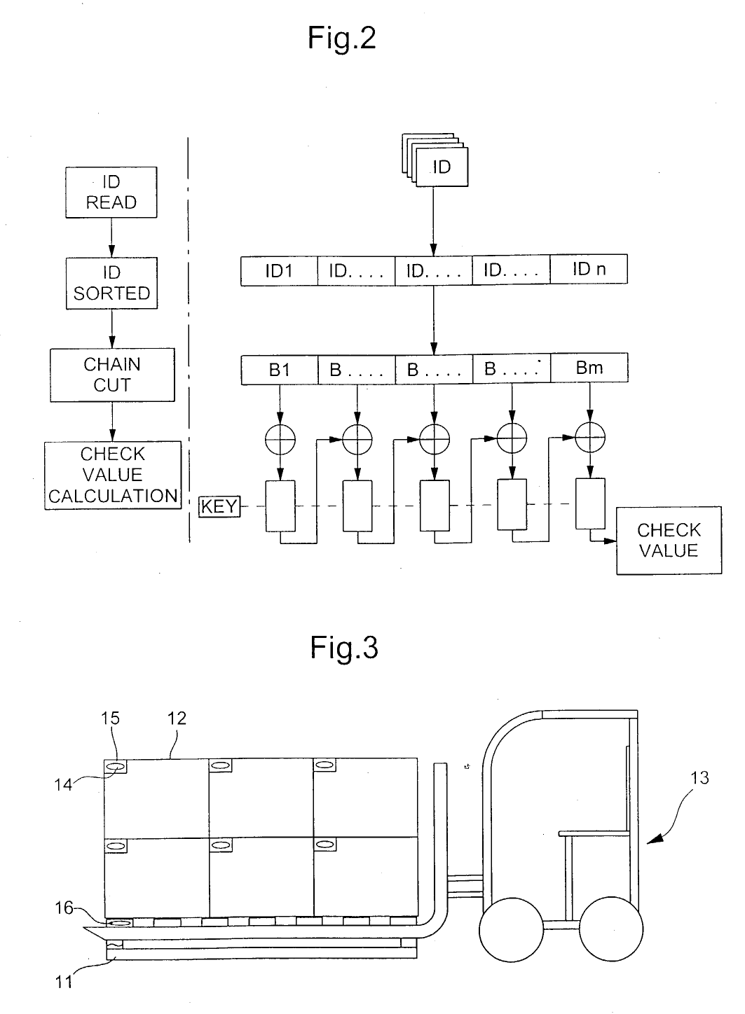

FIG. 2 shows an algorithm example for generating a check value,

FIG. 3 shows an assembly comprising a removable support, according to a second embodiment of the invention,

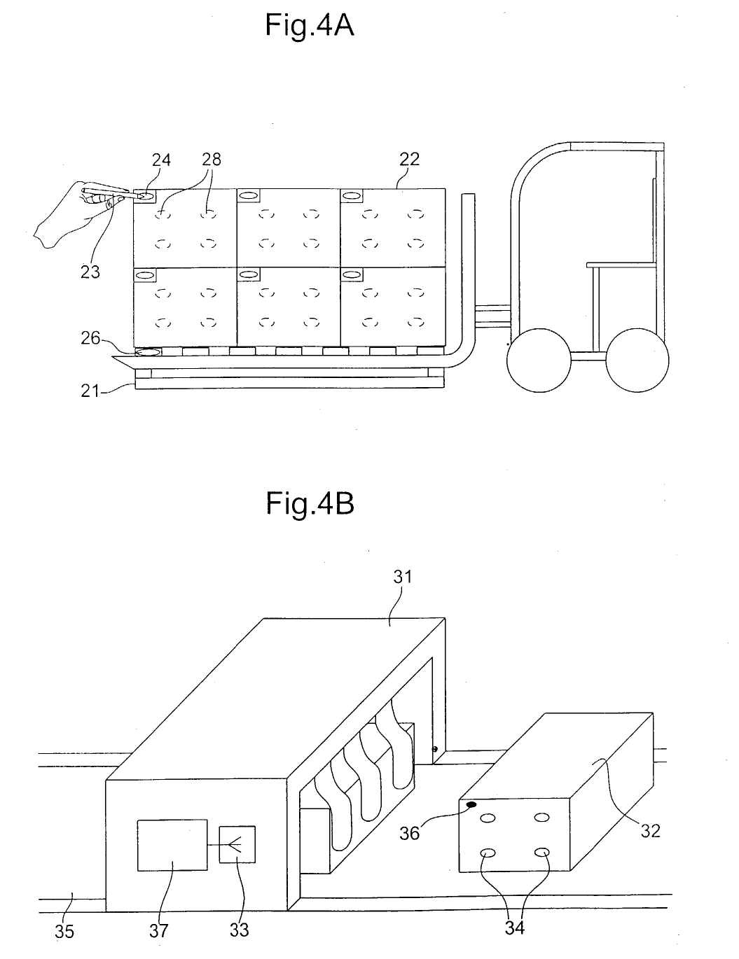

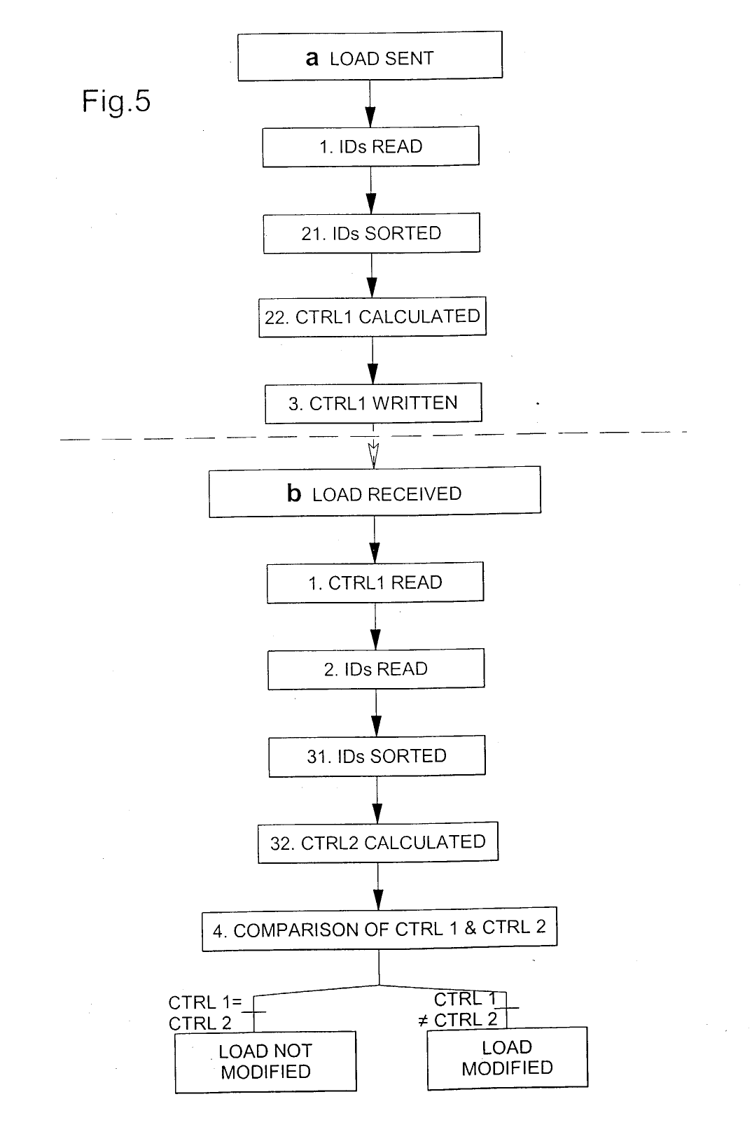

FIGS. 4A and 4B show two variants of the system for checking the integrity of an assembly according to either of the two embodiments of the invention,

FIG. 5 shows an operating diagram of the method for checking the integrity of an assembly according to either of the two embodiments of the invention.

FIG. 1 shows an assembly comprising a container and a plurality of units of goods according to a first embodiment. The container, for example a cardboard box 1, is filled with a plurality of units of goods 2. It is to be noted that these units of goods are preferably packed. One unit of goods 2 is thus formed of a package 4 containing the actual goods.

Each unit of goods 2 is provided with a transponder 3 including as data at least an identification number preferably coded over a significant number of bits, for example 16. In fact, it is preferable to have a wide diversity of identification numbers, in this example 2¹⁶, i.e. 65536 possible numbers, in order to reduce as far as possible any possibility of exchange of units of goods 2 having an identical identification number.

For certain applications, for the sake of reducing costs, passive “Read Only” type transponders 3 are used, i.e. transponders containing data that can be read but not changed.

These transponders 3 are preferably placed at the periphery of goods units 2. In the example illustrated, since goods units 2 are packaged in a cardboard packaging 4, transponder 2 is preferably placed inside against one of internal faces 5 of packaging 4. Thus, any person trying to handle transponder 3 of a unit 2 will necessarily have to damage packaging 4.

Cardboard box 1 is also provided with a transponder 7 able to be arranged for example in an upper corner of one of lateral walls 8 of box 1 and typically associated with a self-adhesive label 9 affixed to box 1, used to indicate the type of goods being transported. An example formed by a transponder and self-adhesive label is disclosed in particular in FR Patent document No. 2 717 593 in relation to FIG. 2 of said document, which is incorporated here by reference.

Transponder 7 used within the scope of this first embodiment, is preferably a Read/Write type passive transponder. This transponder 7 affixed to box 1 contains in a memory a check value, which depends on the identification number of each of transponders 3 with which all the units of goods 2, contained in box 1, are provided. This check value is generated such that it cannot be generated or adapted by an unauthorised person. In order to be fully efficient, calculation of this check value has to be affected by any modifications to at least one identification number of transponders 3 contained in box 1. “Modifications” means the replacement, removal or possibly addition of an identification number able to be consecutive to the replacement, removal or addition of a goods unit 2.

For this purpose, the check value can be calculated in different ways depending, for example, on the desired level of security. If a simple way of calculating this check value is sought, one could for example simply add the identification numbers of the transponders read, or perform a logic operation, for example of the XOR type, between each identification number. It is also possible to perform other operations on the result obtained by addition or logic operation in order to reduce the size of the check value.

If a secure manner of calculating this check value is sought, the calculation is preferably performed by means of a block ciphering algorithm in a standardised chaining configuration, for example “Cipher Block Chaining” (CBC). The encryption algorithm used can be one of the known symmetrical algorithms, like for example “Data Encryption Standard” (DES), “Secure and Fast Encryption Routine” (SAFER) or “Advanced Encryption Standard” (AES). In association with the use of such an encryption algorithm, a ciphering key is used. This ciphering key allows the check value to be generated. It is important that this ciphering key is only provided to authorised persons.

An operating example of such an algorithm for generating a check value is shown in FIG. 2.

According to a first step of this process of generating a check value, all the identification numbers ID are read on the transponders of the goods units.

In a second step, the identification numbers ID collected during the first step are sorted into a defined order (ID1, . . . , . . . IDn), for example ascending or descending order or according to their place in the container, or according to the order in which they are read, so as to form a data chain (ID1, . . . , IDn) or cipher chain.

In a third step, the data chain (ID1, . . . , IDn) created during the second step is cut into blocks (B1, . . . , Bm) corresponding to the ciphering algorithm, for example 32, 64 or 128 bits.

In a fourth step the blocks (B1, . . . Bm) cut off during the third step are ciphered into CBC mode by means of a ciphering key. A chopping value that can be calculated only with the ciphering key is obtained at the output of the ciphering algorithm. It is this chopping value that is used as check value in the transponder affixed to the container.

FIG. 3 shows an assembly including a removable support and a plurality of goods units, according to a second embodiment of the invention. Removable support 11 can for example be a transport pallet 11, or a transport vehicle. Goods units 12 are typically containers, for example cardboard boxes 12, which are loaded onto pallet 11. Once loaded, the pallet is capable of being moved by means of a handling truck 13 for loading one or more pallets 11 and cardboard boxes 12 loaded thereon, into a transport vehicle.

According to this second embodiment, each cardboard 12 is provided with a transponder 14 containing at least an identification number as data. Typically, transponder 14 is associated with a self-adhesive label 15 allowing its position to be easily located.

Transport pallet 11 is provided with a transponder 16 containing a check value dependent on the identification number of each of transponders 14 with which cardboard boxes 12 loaded onto pallet 11 are provided. This check value can be defined in the same way as in the first embodiment referred to hereinbefore.

One thus obtains an assembly comprising a removable support provided with a transponder and a plurality of goods units, for example containers arranged on the support. Each container is provided with a transponder including an identification number, the transponder of the removable support including a check value determined as a function of the identification numbers of each transponder of the containers.

According to an advantageous variant of this second embodiment, the cardboard boxes 12 used for loading pallets 11, are similar to those presented within the scope of the first embodiment. Each transponder 14 corresponding to a cardboard box 12 contains in this case a so-called first level check value defined as in the first embodiment. Each transponder 14 also contains its own identification number. This identification number of transponders 14 of cardboard boxes 12 preferably corresponds to the first level check value. Transponder 16 of the pallet contains a so-called second level check value defined by means of a ciphering key from the identification numbers of transponders 14, these numbers advantageously corresponding to the first level check values. The ciphering keys used for calculating the first and second level check values can be the same.

FIGS. 4A and 4B show two variants of the system for checking the integrity of an assembly according to either of the two embodiments of the invention.

According to a first embodiment shown in FIG. 4A, checking the integrity, for example of a removable support 21 loaded with a plurality of goods units 22, for example cardboard boxes, can occur at any point in the distribution network by authorised persons, i.e. persons possessing the check value calculation algorithm ciphering key. Upon reception, it is advantageous to be able to ensure the integrity of the load before even opening boxes 22. This is why, according to this first variant, the authorised person receiving a load has directive portable checking means 23 able to take the form of a small portable cylindrical object, for example in the form of a pen.

These checking means 23 include, in particular, read means, processing means and comparison means, which are not shown. The read means allow all types of data contained in transponders 24, 26 and 28 to be read, and in particular, the identification numbers of transponders 24 of each box, as well as the check value of transponder 26 of the removable support. This data is read via direct interrogation of each transponder of boxes 22 or support 21 by checking means 23 passing nearby. The processing means allow a check value to be calculated from identification numbers read by means of a ciphering key. Finally, the comparison means allow the check value read on transponder 21 of the removable support to be compared with the calculated check value.

It is important to note that it is possible to perform the same checks between the transponders 28 of each unit of goods contained in a box 22 and the transponder 24 of the corresponding box.

According to a second variant shown in FIG. 4B, the authorised persons have fixed isotropic checking means 31, 33 and 37, for checking the integrity of a container 32 filled with a plurality of goods units, which are not shown. These checking means can be formed for example by an airlock. including read means 33, processing means and comparison means, schematically represented by the rectangle 37, these means having the same functions as those used in the first variant. Airlock 31 can advantageously be arranged on a conveyor belt 35. According to this second variant, read means 33 is typically a read antenna using an anti-collision protocol to read all transponders 34 of the units of goods contained in container 32.

Whatever checking means are used (23 or 31, 33 and 37), if the two check values read and calculated are identical, the load has not been modified. Conversely, if the two values are different, this means that the load has been modified, by the removal, replacement or possibly addition of goods.

It is important to note that the first and second variants have been respectively shown in relation to the second and first embodiments of the invention, but it is entirely possible to envisage adapting these first and second variants respectively in relation to the first and second embodiments according to the invention.

The diagram of the method shown in FIG. 5 concerns an assembly comprising a container or a removable support respectively filled or loaded with a plurality of units of goods.

The transponders of the goods units contain at least one identification number ID as data. The container or the support is fitted with a read/write transponder. The method is broken down into two main parts concerning the steps prior to sending a load and the steps during checking of this load at any stage of the distribution network.

Prior to sending a load, the method includes, in particular, the following steps:

a1. reading the identification numbers (IDs) of the goods unit transponders;

a2. calculating a first check value (CTRL1) from the identification numbers (IDs) read at the preceding step;

a3. writing the first check value (CTRL1) calculated at the preceding step in the container or removable support transponder;

If one is seeking to calculate a check value in a secure manner, step a2 of the method is replaced by the following two steps a21 and a22:

a21. sorting the identification numbers read at the preceding step into a reproducible predefined order so as to form a cipher chain;

a22. calculating a first check value by means of a cipher key (KEY) from the cipher chain obtained at the preceding step;

During a check of the load in the distribution network, the method includes, in particular, the following steps:

b1. reading the first check value (CTRL1) of the container or removable support transponder;

b2. reading the identification numbers (IDs) of the goods unit transponders;

b3. calculating a second check value (CTRL2) from the identification numbers read at the preceding step; these steps being followed by,

b4. comparing the first and second check values (CTRL1 and CTRL2);

If the two check values are different, the load of the assembly formed by the container or the support and the plurality of goods units, has been modified. Conversely, if the two check values are identical, the load has not been modified.

It is to be noted that step b1 can also be carried out equally between steps b2 and b3 or between steps b3 and b4.

If the check value was calculated in a secure manner, step b3 of the method is replaced by the following two steps b31 and b32:

b31. sorting the identification numbers read at the preceding step in the same predefined order used when the load was sent, so as to reform the cipher chain;

b32. calculating a second check value (CTRL2) by means of the cipher key (KEY), from the cipher chain obtained at the preceding step.

It is also to be noted that the steps of the method concerning reception can be carried out several times, particularly if there are several intermediate checks, like for example during customs formalities, or in storage centres prior to distribution.

It will also be noted that the steps of calculating the check values can also be broken down into three sub-steps corresponding to the second, third and fourth steps of FIG. 2, described during presentation of a detailed example of the calculation of check values.

Within the scope of the variant of the second embodiment, having a combination of the two assemblies, i.e. a removable support loaded with a plurality of containers that are themselves filled with a plurality of goods units, the integrity of the load is checked at two levels. The method of checking the integrity of such an assembly with two levels constitutes a repetition of the method presented in FIG. 5 for each sub-assembly formed by each container and its content, as well as an application of the same basic method to the assembly formed by the removable support and the plurality of sub-assemblies.

During a check of the integrity of the load formed by this assembly with two levels, one will first astutely check the second level check value corresponding to that of the assembly, then only if the second level read and calculated check values are identical, can one check the first level check values of each sub-assembly.

It is also possible to carry out a check of the integrity of a distribution network through an assembly with more than two levels, where each assembly is provided with a transponder including a check value dependent on each sub-assembly that it includes, this assembly also being able to be a sub-assembly of a larger assembly.

By way of variant according to one of the embodiments presented hereinbefore, in particular in the case of a luxury item already including transponders to ensure their traceability, it is proposed to use these existing transponders as the goods unit transponders.

Also by way of variant, according to one of the embodiments presented hereinbefore, it is possible to provide that at least one of the transponders of one of the goods units is a Read Write type transponder. In this case the check value for ensuring the integrity of the load can be stored in the memory of this at least one Read Write transponder.

By way of additional variant, it is possible to adapt an assembly in accordance with one of the embodiments so as also to ensure a traceability function for this device.

Advantageously, the choice of transponders used can be adapted as a function of the value of the units of goods. In the case of luxury goods, relatively expensive active transponders can be used since they represent a negligible extra cost. However, in the case of inexpensive products, read only passive transponders are used for the goods units and read-write passive transponders are used for the storage device, which avoids generating prohibitive extra costs.

It is clear that the description is only given by way of example and that other embodiments, in particular assemblies that can be formed by a vehicle and its load, by a warehouse and its stock, on condition that they satisfy the conditions of claim 1, as well as associated checking methods, also form the subject of the present invention.

What is claimed is:

1. An assembly including a container provided with a transponder and a plurality of units of goods filling the container, each unit of goods being provided with a transponder including an identification number, the container transponder including, in a memory, a check value determined as a function of the identification number of each transponder of said units of goods.

2. The assembly according to claim 1, wherein the units of goods are positioned such that their transponder is at the periphery of the container.

3. The assembly according to claim 1, wherein the container transponder is a read/write transponder and in that the goods unit transponders are read only transponders.

4. An assembly comprising a removable support provided with a transponder and a plurality of units of goods arranged on said support, each unit of goods being provided with a transponder including an identification number, the container transponder including, in a memory, a check value determined as a function of the identification number of each transponder of said units of goods.

5. An assembly including a removable support according to claim 4, wherein each unit of goods forms a container filled with sub-units of goods.

6. An assembly with at least two levels including:
a removable support comprising a plurality of containers, each container being provided with a transponder including an identification number, the removable support being provided with a transponder including a first level check value determined as a function of the identification numbers of each transponder of said containers,
each container being filled with a plurality of units of goods, each unit of goods being provided with a transponder including an identification number, the transponder of each container including a second level check value determined as a function of the identification numbers of each transponder of said units of goods that it contains.

7. The assembly according to claim 6, wherein the identification number of each container transponder corresponds to the first level check value contained in this transponder.

8. The method for checking the integrity of an assembly according to claim 1, wherein it includes the following steps:
prior to sending goods:
a1. reading the identification numbers of the goods unit transponders;
a2. calculating a first check value from the identification numbers read at the preceding step;
a3. writing the first check value calculated at the preceding step respectively in the container or removable support transponder;
during a goods check:
b1. reading the first check value respectively in the container or removable support transponder;
b2. reading the identification numbers of the goods unit transponders;
b3. calculating a second check value from the identification numbers read at the preceding step; these steps being followed by,
b4. comparing the first and second check values.

9. The checking method according to claim 8, wherein prior to sending goods, step a2 is replaced by the following two steps:
a21. sorting the identification numbers read at the preceding step into a reproducible predefined order so as to form a cipher chain;
a22. calculating a first check value by means of a cipher key from the cipher chain obtained at the preceding step;
and in that during a goods check, step b3 is replaced by the following two steps:
b31. sorting the identification numbers read at the preceding step in the same predefined order used when the goods was sent, so as to reform the cipher chain;
b32. calculating a second check value by means of the cipher key, from the cipher chain obtained at the preceding step.

10. The method for checking the integrity of an assembly according to claim 4, wherein it includes the following steps:
prior to sending goods:
a1. reading the identification numbers of the goods unit transponders;
a2. calculating a first check value from the identification numbers read at the preceding step;
a3. writing the first check value calculated at the preceding step respectively in the container or removable support transponder;
during a goods check:
b1. reading the first check value respectively in the container or removable support transponder;
b2. reading the identification numbers of the goods unit transponders;
b3. calculating a second check value from the identification numbers read at the preceding step; these steps being followed by,
b4. comparing the first and second check values.

11. The checking method according to claim 10, wherein prior to sending goods, step a2 is replaced by the following two steps:
a21. sorting the identification numbers read at the preceding step into a reproducible predefined order so as to form a cipher chain;
a22. calculating a first check value by means of a cipher key from the cipher chain obtained at the preceding step;
and in that during a goods check, step b3 is replaced by the following two steps:
b31. sorting the identification numbers read at the preceding step in the same predefined order used when the goods was sent, so as to reform the cipher chain;
b32. calculating a second check value by means of the cipher key, from the cipher chain obtained at the preceding step.

12. The system for checking the integrity of an assembly according to claim 1, comprising checking means that are external to the assembly, including read means for the data contained in the transponders, means for calculating the check values by means of a cipher key, and means for comparing the check values.

13. The checking system according to claim 12, wherein the checking means are portable and directive.

14. The checking system according to claim 12, wherein the checking means are fixed and isotropic.

15. The system for checking the integrity of an assembly according to claim 4, comprising checking means that are external to the assembly, including read means for the data contained in the transponders, means for calculating the check values by means of a cipher key, and means for comparing the check values.

16. The checking system according to claim 15, wherein the checking means are portable and directive.

17. The checking system according to claim 15, wherein the checking means are fixed and isotropic.

18. The system for checking the integrity of an assembly according to claim 7, comprising checking means that are external to the assembly, including read means for the data contained in the transponders, means for calculating the check values by means of a cipher key, and means for comparing the check values.

19. An assembly including a container and a plurality of units of goods filling the container, each unit of goods being provided with a transponder including an identification number, wherein at least one of the transponders of one of the units of goods is a read/write transponder including, in a memory, a check value determined as a function of each transponder of said units of goods.

20. An assembly including a removable support and a plurality of units of goods arranged on said support, each unit of goods being provided with a transponder including an identification number, wherein at least one of the transponders of one of the units of goods is a read/write transponder including, in a memory, a check value determined as a function of the identification number of each transponder of said units of goods.
